(19) United States
(12) Patent Application Publication
(10) Pub. No.: US 2025/0246936 A1
(43) Pub. Date: Jul. 31, 2025

(54) ELECTRODE ASSEMBLY AND SYSTEM EQUIPPED THEREWITH FOR PERFORMING WIRELESS POWER TRANSFER BASED ON RESONANT CAPACITIVE COUPLING

(71) Applicant: AWL-ELECTRICITY INC, MONTREAL (CA)

(72) Inventors: Emmanuel GLEN, MONTREAL (CA); Ben-Haim AMRAM, BROSSARD (CA); Dave DUFOUR, ST-HYACINTHE (CA); Francois LEVEILLE, MONTREAL (CA); Cedric HAMEL-BRUNEAU, MONTREAL (CA)

(73) Assignee: AWL-ELECTRICITY INC, MONTREAL, QC (CA)

(21) Appl. No.: 18/855,074

(22) PCT Filed: Apr. 4, 2023
(86) PCT No.: PCT/CA2023/050455

§ 371 Date: Oct. 8, 2024

Related U.S. Application Data
(60) Provisional application No. 63/330,847, filed on Apr. 14, 2022.

(51) Int. Cl. H02J 50/00; H02J 50/05

(52) U.S. Cl. CPC H02J 50/005; H02J 50/05

(57) ABSTRACT

The present electrode assembly comprises a plurality of adjacent electrically conductive plates separated by a spacing therebetween. The electrode assembly further comprises at least one electrical component interconnecting the adjacent electrically conductive plates. A system equipped with the present electrode assembly is also provided for performing wireless power transfer based on resonant capacitive coupling.

### TECHNICAL FIELD

The present disclosure relates to the field of wireless power transfer of electrical energy. More specifically, the present disclosure presents an electrode assembly and a system equipped therewith for performing wireless power transfer based on resonant capacitive coupling.

### BACKGROUND

Wireless power transfer of electrical energy is based on the capability of transferring electrical energy from a transmitter (which generates the power to be transferred) to a receiver (which consumes the transferred power), without establishing a physical contact between the transmitter and the receiver. The usage of wireless power transfer avoids the usage of an electrical connector (e.g. an electrical power outlet or a Universal Serial Bus (USB) cable) between the transmitter of electrical energy and the receiver of electrical energy.

Various techniques for implementing wireless power transfer have been studied over the years (although implementation of these techniques on an industrial and commercial scale are more recent). For example, induction systems use an induction coil at the transmitter and an induction coil at the receiver for implementing the wireless power transfer functionality. The wireless power transfer functionality is based on a coupling of magnetic fields generated between the induction coil of the transmitter and the induction coil of the receiver. The efficiency of induction systems can be improved by using resonant magnetic fields.

Another example includes electric field coupling systems, which use capacitive electrodes at the transmitter and the receiver for implementing the wireless power transfer functionality. The wireless power transfer functionality is based on a coupling of electric fields between the capacitive electrodes of the transmitter and the capacitive electrodes of the receiver. The efficiency of electric field coupling systems can also be improved by relying on resonant electric fields.

Systems using resonant electric fields operating at a high frequency are referred to as high frequency resonant capacitive coupling systems. Such systems have advantages in terms of security (e.g. no energy is displaced in the air which avoids health hazards, no eddy current is generated which avoids material damage caused by heat generation, operations at a safe frequency according to government standards). Such systems also have advantages in terms of operational robustness (e.g. resilience to misalignment of receiver and transmitter).

The present disclosure aims at providing an improved wireless power transfer system and electrode assembly based on the coupling of resonant electric fields, capable of operating at a high frequency, and with greater wireless power transfer capacity. The present improved wireless power transfer system, electrode and electrode assembly may be used for charging the battery of devices having a greater power capacity or greater power demand (and for which the user-friendliness of the charging process is of paramount importance). For example, the present improved wireless power transfer system and electrode assembly may be used for contactlessly charging the battery of electrically powered wheelchairs, hence greatly facilitating the everyday life of the users of the wheelchairs.

Therefore, there is a need for an improved system and electrode assembly for performing wireless power transfer based on resonant capacitive coupling.

### SUMMARY

According to a first aspect, the present disclosure provides an electrode assembly for wireless power transfer based on resonant capacitive coupling. The electrode assembly comprises a plurality of adjacent electrically conductive plates separated by a spacing therebetween. The electrode assembly further comprises at least one electrical component interconnecting the adjacent electrically conductive plates.

According to a second aspect, the present disclosure provides an electrode assembly for performing wireless power transfer based on resonant capacitive coupling. The electrode assembly comprises a plurality of conductive plates separated by a spacing therebetween. The electrode assembly further comprises at least one electrical component interconnecting two spaced conductive plates, and a supporting frame adapted for maintaining the plurality of conductive plates.

According to a third aspect, the present disclosure provides a wireless power transfer system. The wireless power transfer system comprises a transmitter and a receiver each provided with at least one electrode assembly. The electrode assembly comprises a plurality of adjacent electrically conductive plates separated by a spacing therebetween, and at least one electrical component interconnecting the adjacent electrically conductive plates.

### BRIEF DESCRIPTION OF THE DRAWINGS

Embodiments of the disclosure will be described by way of example only with reference to the accompanying drawings, in which:

FIG. 1 is a schematic representation of a wireless power transfer system;

FIGS. 2A, 2B, 2C and 2D represent several exemplary configurations of electrode assembly;

FIG. 3 represents another exemplary configuration of an electrode assembly;

FIGS. 4A, 4B, 4C and 4D respectively represent front, profile, side and top views of another exemplary configuration of electrode assembly comprising a plurality of stacked conductive plates; and

FIGS. 5A-5C respectively represent other exemplary configurations of electrode assembly;

FIGS. 6A-6C represent exemplary functional diagrams of the wireless power transfer system of FIG. 1 with one electrode assembly at the transmitter and the receiver; and

FIGS. 7A-7C represent exemplary functional diagrams of wireless power transfer system of FIG. 1 with two electrode assemblies at the transmitter and the receiver.

### DETAILED DESCRIPTION

The foregoing and other features will become more apparent upon reading of the following non-restrictive description of illustrative embodiments thereof, given by way of example only with reference to the accompanying drawings.

Various aspects of the present disclosure generally address one or more of the problems related to the limitations in terms of wireless power transfer capacity of systems based on the coupling of resonant electric fields. In this context, a system comprising a transmitting electrode assembly and a receiving electrode assembly is disclosed. The system and electrode assembly are designed to improve the power transfer capacity of the wireless power transfer process. Furthermore, the system and electrode assembly rely on the generation of a capacitive resonant electric field for transferring the electrical power from the transmitter to the receiver.

Throughout the present description, the expression electrode assembly is used to refer to a group of conductive plates, either adjacent, stacked or concentrically positioned, in which at least two of the conductive plates are electrically interconnected.

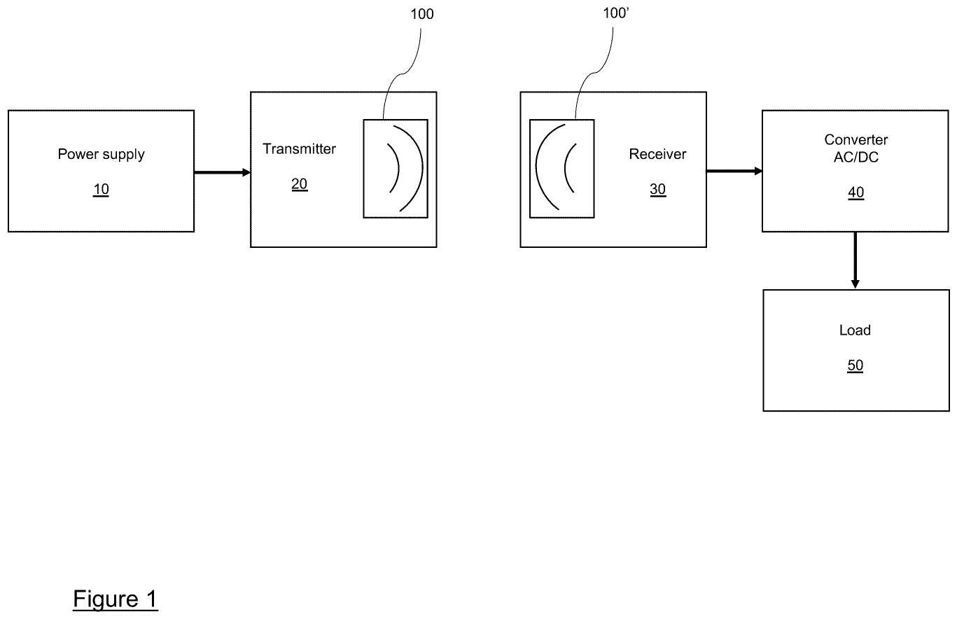

Reference is now made to FIG. 1, where a wireless power transfer system is schematically represented. At least one transmitting electrode assembly 100 is integrated to a transmitter circuit 20 powered by a power supply 10. At least one receiving electrode assembly 100′ is integrated to a receiver circuit 30 connected to an AC/DC converter 40, the AC/DC converter 40 providing electrical power to one or several loads 50 (e.g. electrical motor, electronic circuit, one or several batteries, etc.). Electrical power generated by the power supply 10 is wirelessly transferred to the AC/DC converter 40, via resonant capacitive coupling of the electrode assemblies 100 and 100′. In a usual implementation, the transmitter circuit 20 is electrically connected to one or several transmitting electrode assemblies 100 respectively coupled with one or several corresponding receiving electrode assemblies 100′ electrically connected to the receiver circuit 30.

In the following, various configurations of electrode assemblies will be described. Any of the following configurations may be used for the electrode assembly 100 transmitting the electrical power or for the electrode assembly 100′ receiving the electrical power. Thus, the transmitting (100) and receiving (100′) electrode assemblies may use the same or different electrode assembly configurations.

The shape, dimensions and configurations of the present electrode assembly may vary. However, the various configurations of the present electrode assembly share the following common particularities: multiple conductive plates, where each conductive plate is electrically interconnected by one or several electrical components to at least another conductive plate.

The present electrode assembly establishes an electric field (transmitting electrode assembly) or coupling with an electric field (receiving electrode assembly). Any electrode assembly may thus play the role of a transmitting electrode assembly (when generating the electric field) and a receiving electrode assembly (when coupled to the generated electric field).

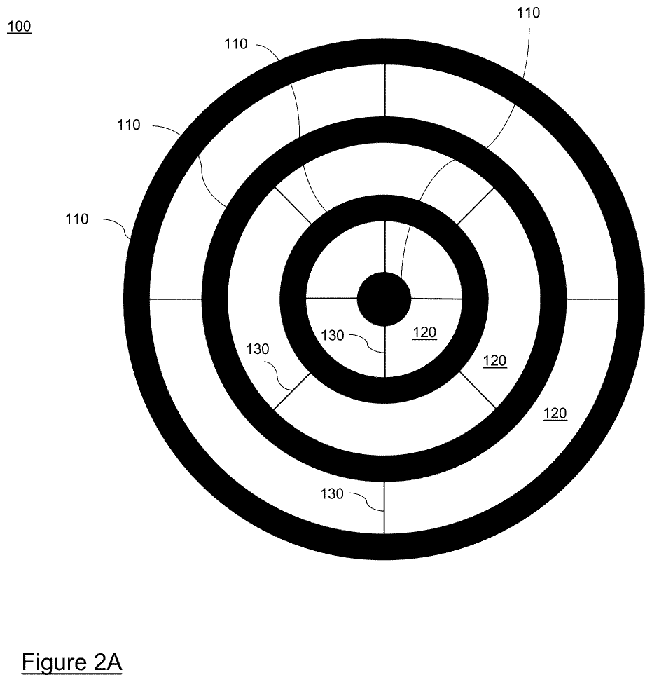

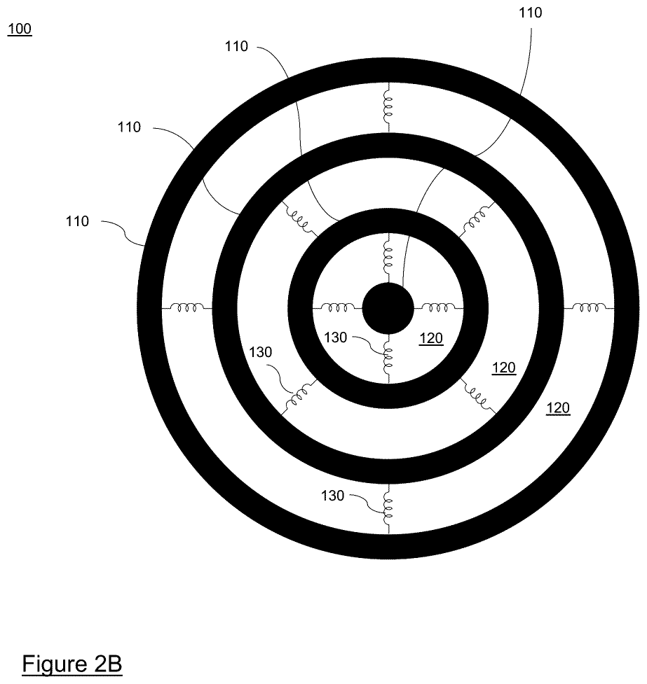

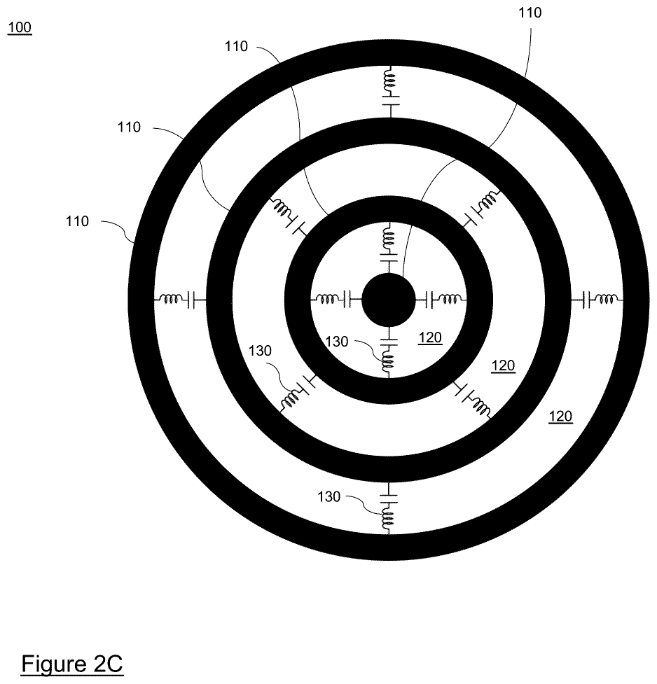

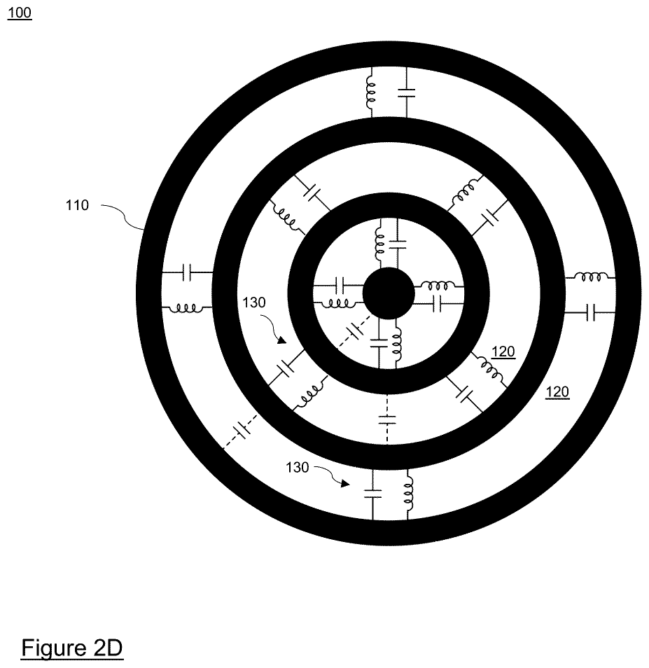

Reference is now made concurrently to FIGS. 2A-2D representing exemplary configurations of the electrode assembly 100. The illustrated exemplary configurations of electrode assembly 100 comprise a plurality of circular conductive plates 110 concentrically positioned. The exemplary configurations illustrated in FIGS. 2A-2D comprise one external conductive plate, one central conductive plate, and two conductive plates in between. These exemplary configurations of electrode assembly are for illustration purposes only. The electrode assembly 100 may comprise any number N of conductive plates 110, with N greater than two. Additionally, a respective position of the conductive plates 110 within the electrode assembly 100 may vary, a width of the conductive plates 110 may vary, spacing 120 between consecutive conductive plates 110 may vary, etc.

The conductive plates 110 are made of an electrically conductive material. Thus, each conductive plate 110 is an electrical conductor. For example, the conductive plates 110 may be made of one of the following materials: aluminum, copper, etc. A combination or alloy of two or more materials may also be used for building the conductive plates 110. For example, the combination or alloy may include at least one of aluminum and copper. Additionally, the conductive plates 110 of the electrode assembly may be made of different materials.

The spacing 120 between the conductive plates 110 may be used for introducing a vacuum or filled with a gas, or ambient air. Alternatively, the spacing 120 may be filled with a fluid or with a solid material such as a Printed Circuit Board (PCB) or any similar board (hereinafter concurrently referred for simplicity as PCB).

The electrode assembly 100 further comprises one or multiple electrical components 130 between the conductive plates 110. At least two conductive plates 110 of the electrode assembly 100 are electrically interconnected by at least one electrical component 130. In a particular implementation, each conductive plate 110 of an electrode assembly 100 is electrically interconnected to another conductive plate 110 of the electrode assembly 100 by at least one electrical component 130.

The electrical components 130 may comprise one or several of the following: conductive component(s), inductance(s) or electrical component(s) with inducting properties, conductance(s) or electrical component(s) with conductive properties, switch(es), transistor(s), diode(s). When multiple electrical components 130 electrically interconnect two conductive plates 110, the multiple electrical components 130 may be electrically connected in series (as in FIG. 2C), in parallel (as in FIG. 2D) or in a combination of both in series and in parallel electrical components (not shown) to interconnect the conductive plates 110.

FIG. 2A illustrates a configuration where each conductive plate 130 is interconnected to at least one other conductive plate 130 by multiple electrical components 130 consisting specifically of electrically conductive components: e.g., cable, line, or resistor. FIG. 2B illustrates a configuration where the electrical components 130 interconnecting the conductive plates 110 are inductances or have inducting properties. FIG. 2C illustrates a configuration where the electrical components 130 have both inductive and capacitive properties connected in series while FIG. 2D illustrates electrical components 130 having inductive and capacitive properties connected in series. In another configuration not represented in the Figures, the electrical components 130 only have capacitive properties.

Although FIGS. 2A-2D depict an identical number of electrical components 130 interconnecting the conductive plates 110, the present electrode assembly 100 is not limited to such configurations. For example, the number, positioning and/or types of electrical components 130 may be different between conductive plates 110 of the same electrode assembly 100. Furthermore, the electrical properties (e.g. resistance, inductance, conductance, delay . . . ) of the electrical components may be identical or different between different conductive plates 110. Although shown as independent and separate in FIGS. 2A-2D, those skilled in the art will understand that the conductive plates 110 and the electrical components 130 may be affixed or traced to PCB, and the conductive plates 110 and the electrical components 130 may also be affixed or traced to multiple PCBs.

FIGS. 2A-2D illustrate exemplary configurations where consecutive conductive plates 110 are interconnected by four evenly distributed (at an angle of 90 degrees with one another) electrical components 130. This configuration is for illustration purposes only. The number of electrical components 130 interconnecting two conductive plates 110 may vary. The distribution pattern of the electrical components 130 interconnecting two conductive plates 110 may also vary. For example, the external conductive plate 110 may be referred to as A₁, the next conductive plate 110 may be referred to as A₂, the next conductive plate 110 may be referred to as A₃ and the central conductive plate 110 referred to as A₄. As illustrated in the exemplary configuration of FIGS. 2A-D, the distribution pattern of the electrical components 130 between the consecutive conductive plates A₁ and A₂ and the consecutive conductive plates A₃ and A₄ is similar, but at a different angle from the distribution pattern of the electrical components 130 between the consecutive conductive plates A₂ and A₃.

The conductive plates 110 of FIGS. 2A-2D are depicted as concentric rings, except for the central conductive plate 110 which is depicted as a circle (with no void inside). Each ring is defined by an outer radius and an inner radius with respect to a central axis of the ring. The cylinder is defined by a single radius with respect to a central axis of the cylinder. The outer radius of ring A₁ is greater than the inner radius of ring A₁, which is greater than the outer radius of ring A₂, which is greater than the inner radius of ring A₂, which is greater than the outer radius of ring A₃, which is greater than the inner radius of ring A₃, which is greater than the radius of cylinder A₄. Alternatively, the central conductive plate 110 may also be a ring instead of a circle with a space inside.

Although FIGS. 2A-2D illustrate circular conductive plates 110, other geometric shapes could also be used. For example, the conductive plates 110 could be elliptical, polygonal (rectangular, octagonal, etc.), concave, convex, etc.

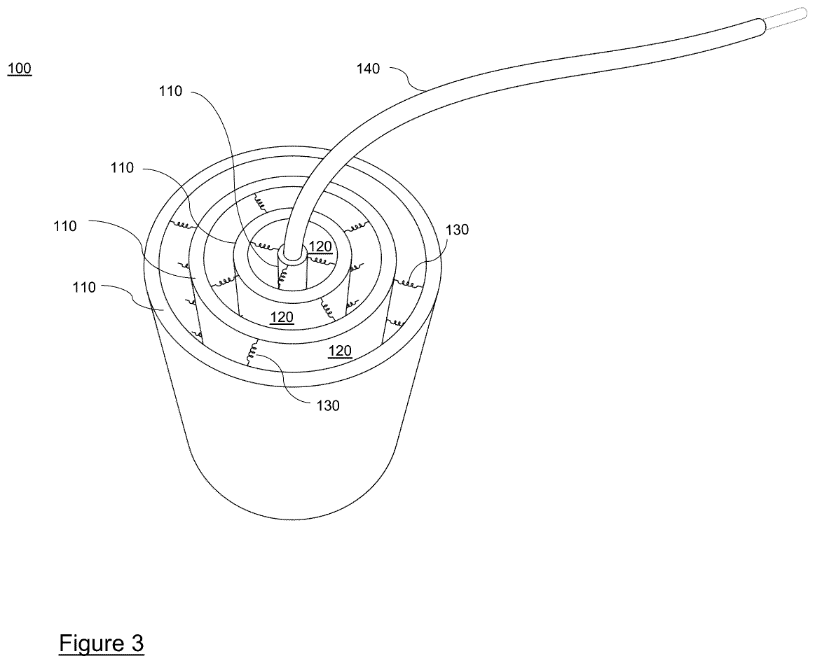

Referring now to FIG. 3, an alternative configuration of the electrode assembly 100 is provided. In the depicted configuration, the conductive plates 110 are 3D conductive plates depicted as concentric hollow cylinders. From a geometric perspective, the conductive plates 110 of the configuration shown on FIG. 3 correspond to the conductive plates 110 shown on FIGS. 2A-2D with added height for providing the third dimension. The height of the conductive plates may for example be in any order of magnitude greater (e.g. 2, 5, 10, 50 or 100 times) than a width of the conductive plates 110.

The consecutive conductive plates 110 of FIG. 3 are also separated by spacings 120, which may have the same characteristics and properties of the spacings mentioned previously in reference to FIGS. 2A-2D.

The conductive plates 110 of FIG. 3 are also interconnected by the electrical components 130. In addition to being interconnected with respect to their circumference as previously depicted and discussed, the conductive plates 110 may further be interconnected along their height by the electrical components 130. The distribution of electrical components along the height of the conductive plates 110 may be identical between consecutive conductive plates 110 or different between the consecutive conductive plates 110. The electrical components 130 have the same characteristics and properties as mentioned previously in reference to FIGS. 2A-2D. The number and distribution of the electrical components 130 can be determined experimentally, to optimize the effects of the electrical components 130 on the electrical field generated by the electrode assembly 100 of the transmitter and the electrode assembly 100 of the receiver.

The electrode assembly 100 further comprises an electrical connector 140 for connecting the electrode assembly 100 to a resonant electric/electronic circuit of the transmitter 20 or of the receiver 30 represented in FIG. 1. The electrical connector 140 may pass through a hollow of the central conductive plate 110. However, the electrical connector 140 may be positioned differently (e.g. in close proximity of the external conductive plate 110).

Although not shown in FIGS. 2A-2D, those skilled in art will understand that the electrode assembly 100 of FIGS. 2A-2D further comprises an electrical connector 140 in a manner similar to the one illustrated or discussed in support of FIG. 3 for connecting the electrode assembly 100 to the transmitter 20 or the receiver 30.

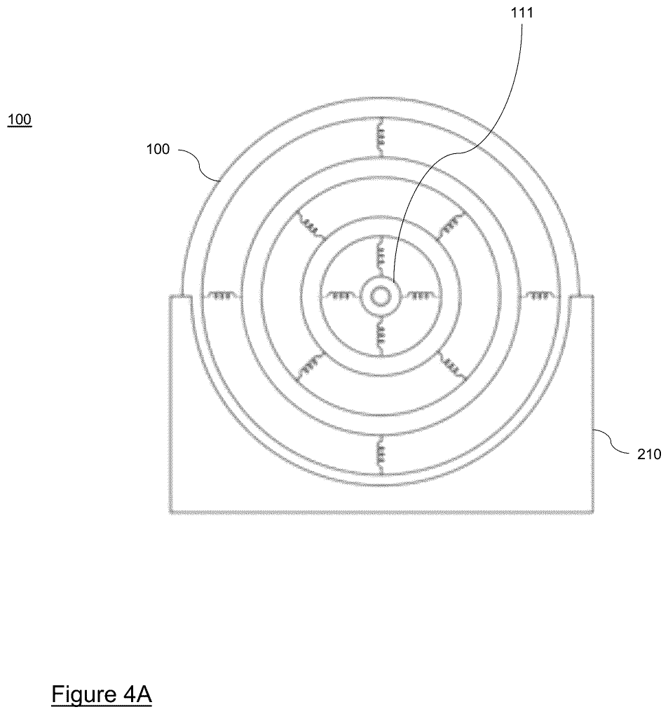

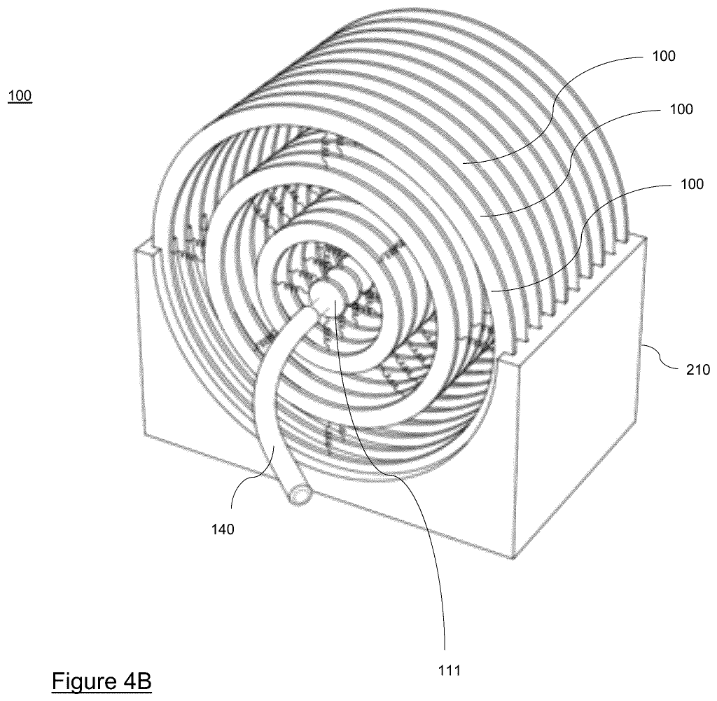

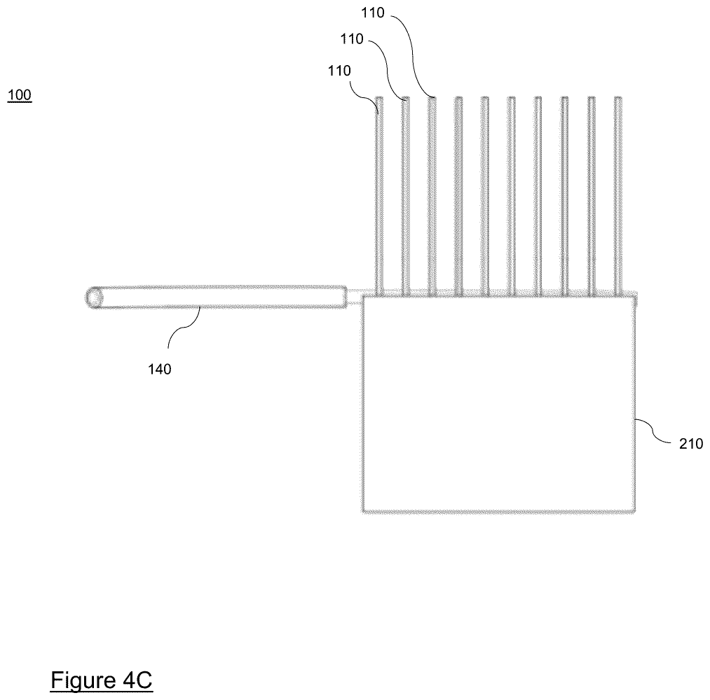

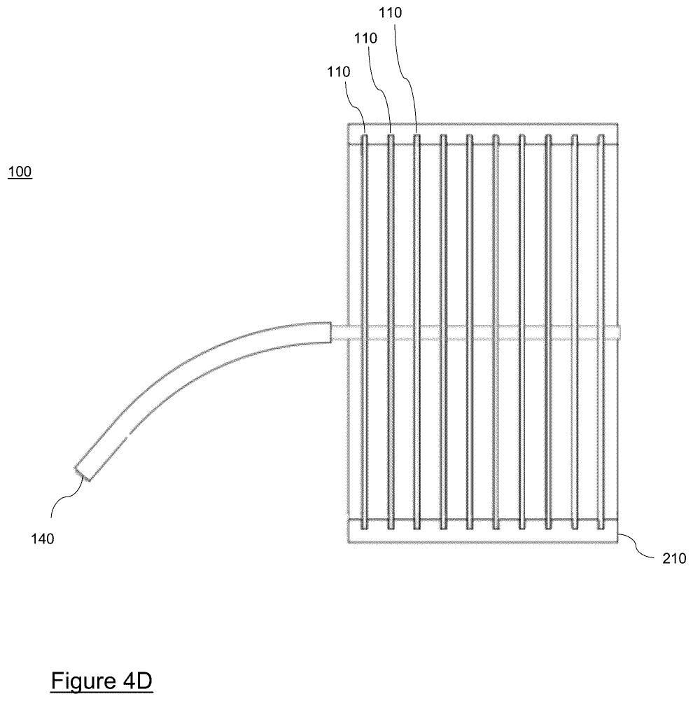

Reference is now made concurrently to FIGS. 4A, 4B, 4C and 4D representing another configuration of electrode assembly 100. FIG. 4A is a front view of the electrode assembly 100. FIG. 4B is a profile view of the electrode assembly 100. FIG. 4C is a side view of the electrode assembly 100. FIG. 4D is a top view of the electrode assembly 100.

The electrode assembly 100 of FIGS. 4A-4D comprises a plurality of adjacent conductive plates 110. FIGS. 4A, 4B, 4C and 4D illustrates adjacent conductive plates 110 that are horizontally stacked. Although not represented in the FIGS. 4A-4D, the conductive plates 110 could be vertically stacked or simply positioned one next to another with or without being stacked partially or entirely. Although depicted as flat conductive plates, the conductive plates 100 of the present electrode assembly may not be completely flat and could be at least partially concave or convex.

The electrode assembly 100 of FIGS. 4A-4D further comprises a supporting frame 210 adapted for maintaining the conductive plates 110 in the stacked position. The design of the supporting frame 210 may vary. For example, in the configuration illustrated in FIGS. 4A-4D, the supporting frame 210 comprises a plurality of semi-circular grooves for receiving the conductive plates 110: two consecutive grooves being separated by a distance adapted corresponding to the spacing 120 between the consecutive conductive plates 110. Alternatively, and not shown in FIGS. 4A-4D, the supporting frame 210 may maintain the conductive plates 110 adjacent, in any of the following positionings: adjacent without overlap, adjacent and partially overlapped, or completely stacked.

Although shown as stacked concentric rings, the electrodes of shown in FIGS. 4A-4D are not limited to such a configuration and any previously described electrode configuration could be used stacked, partially overlapped or adjacently positioned with no overlap.

The electrode assembly 100 further comprises the electrical connector 140 electrically connecting the conductive plates 110 to the transmitter 20 or the receiver 30 represented in FIG. 1. In the implementation illustrated in FIGS. 4A-4D, the electrical connector 140 passes through a central ring-shaped plate 110 of each conductive plate 110. However, as mentioned previously, the electrical connector 140 may be positioned differently.

The electrical components 130 interconnecting the conductive plates 110 of the electrode assembly 100 may be configured, positioned, distributed and selected as previously discussed.

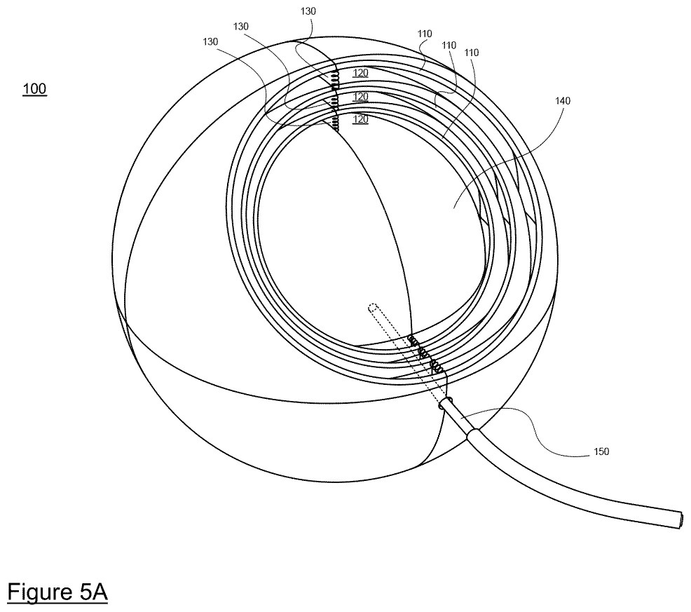

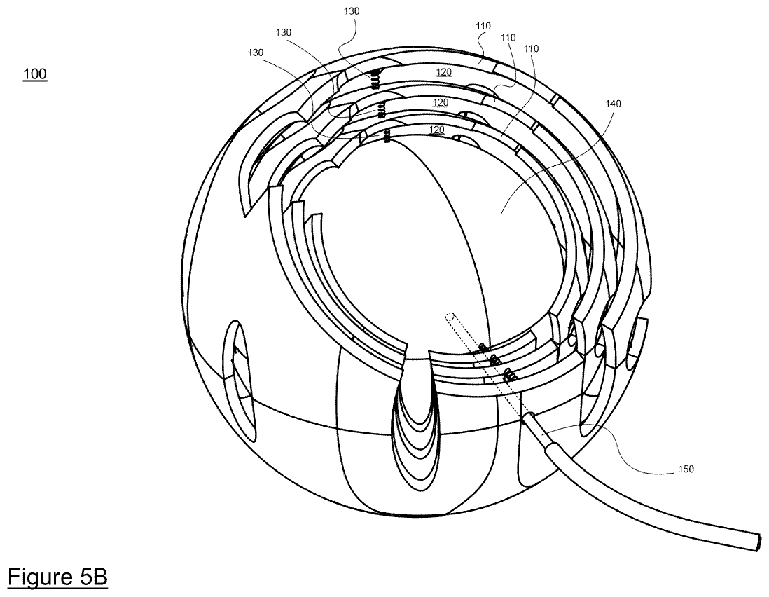

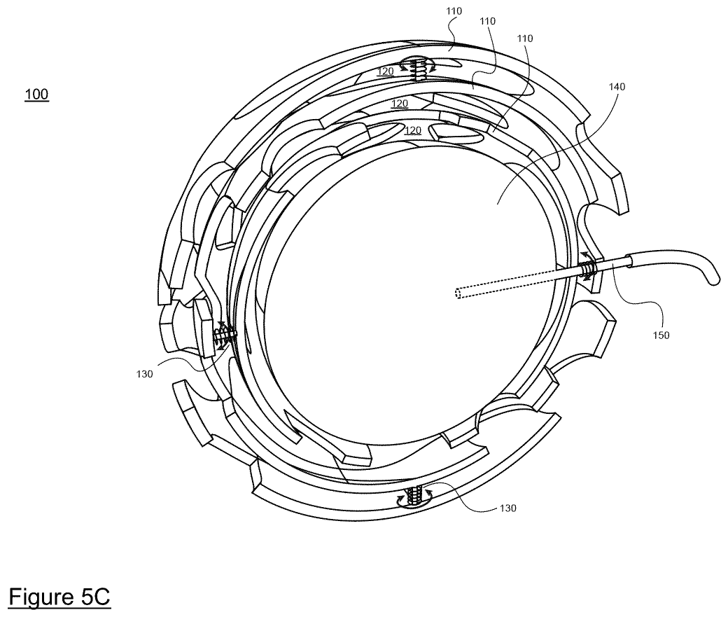

Referring now to FIGS. 5A-5C, another configuration of electrode assembly 100 is depicted. More particularly, the configuration of electrode assembly depicted is based on spherical conductive plates 110 interconnected by electric components 130. The selection, configuration and distribution of electric components 130 may correspond to any of the various combinations previously discussed. The electric components 130 may be positioned at or along pivot points maintaining and separating the consecutive spherical conductive plates 110.

Referring now to FIGS. 1, 2A-2D, 3, 4A-4D, 5A-5C, the various configurations of electrode assemblies depicted and discussed above combine the electrical conductivity of multiple conductive plates 110 thereby increasing the energy transmitted while minimizing the footprint required. Thus, the various configurations of the present electrode assembly 100 improve at least one of the following factors: size, efficiency, wireless power transfer capabilities, distance of operation, security, ergonomics, and aesthetics.

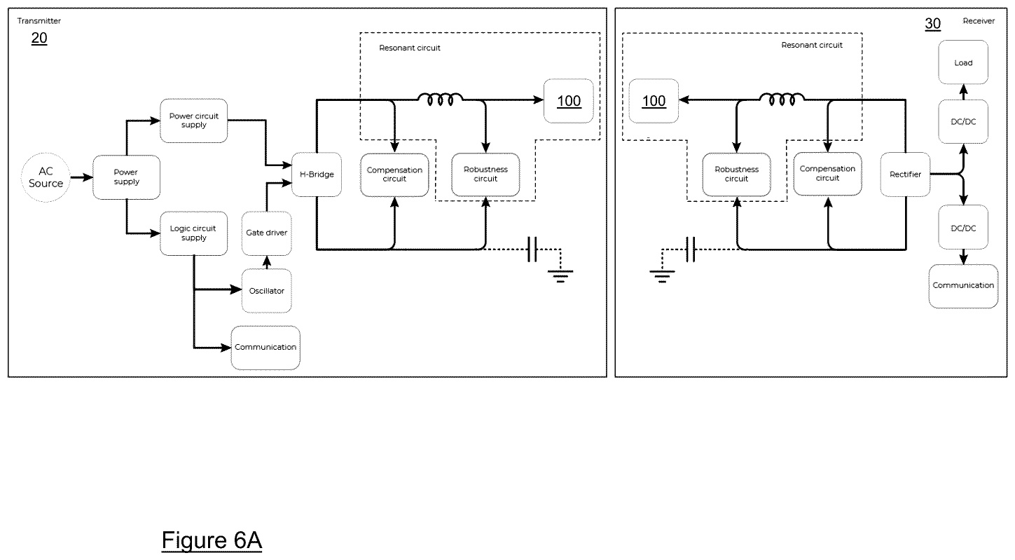

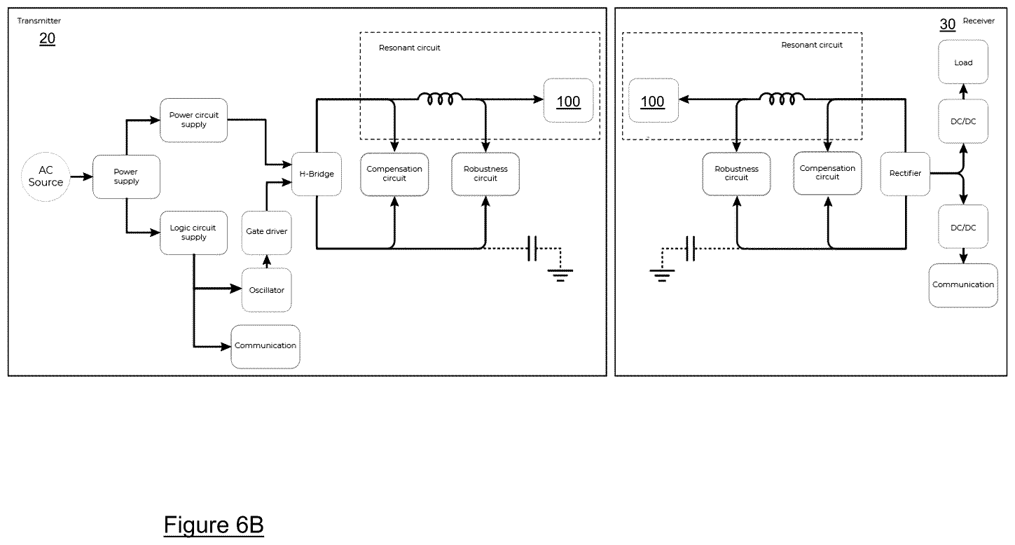

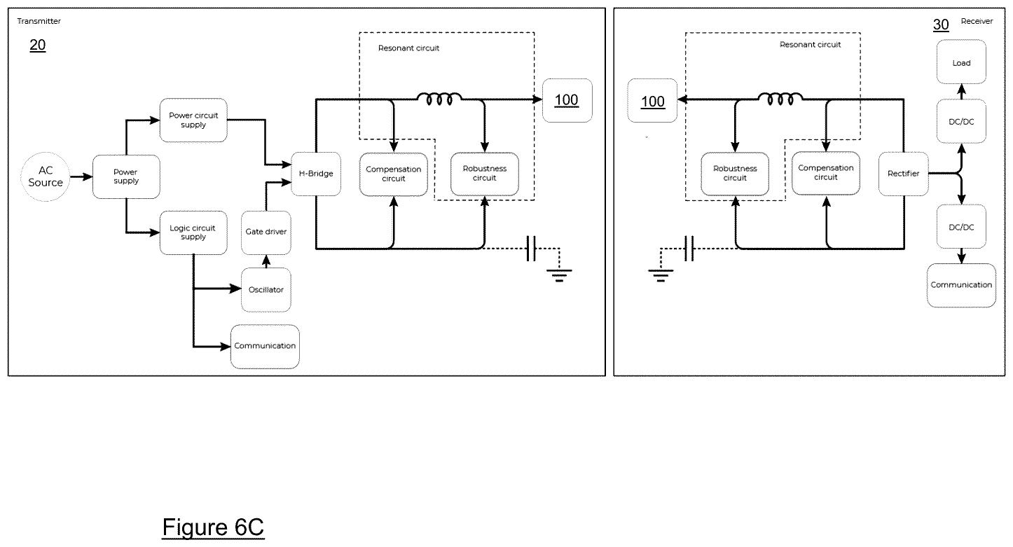

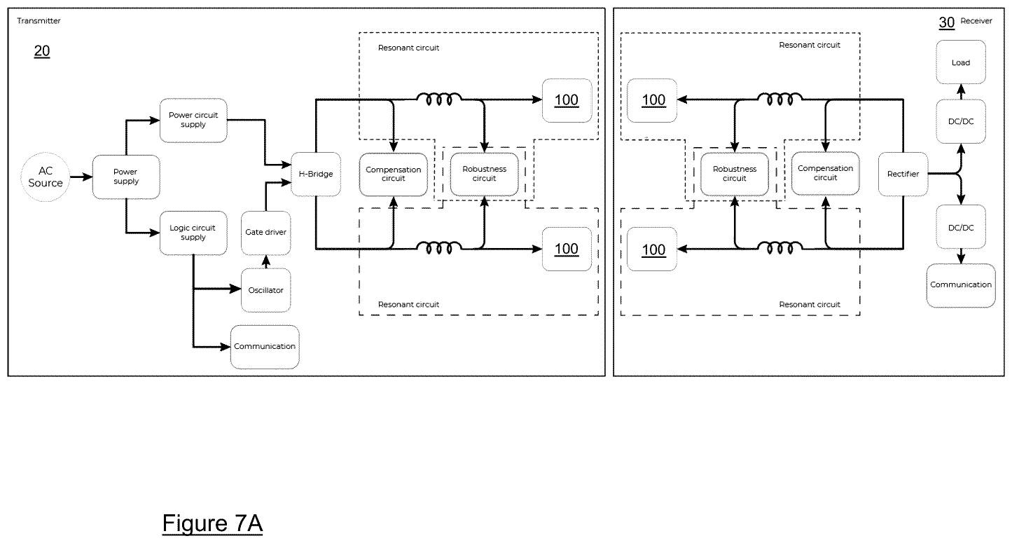

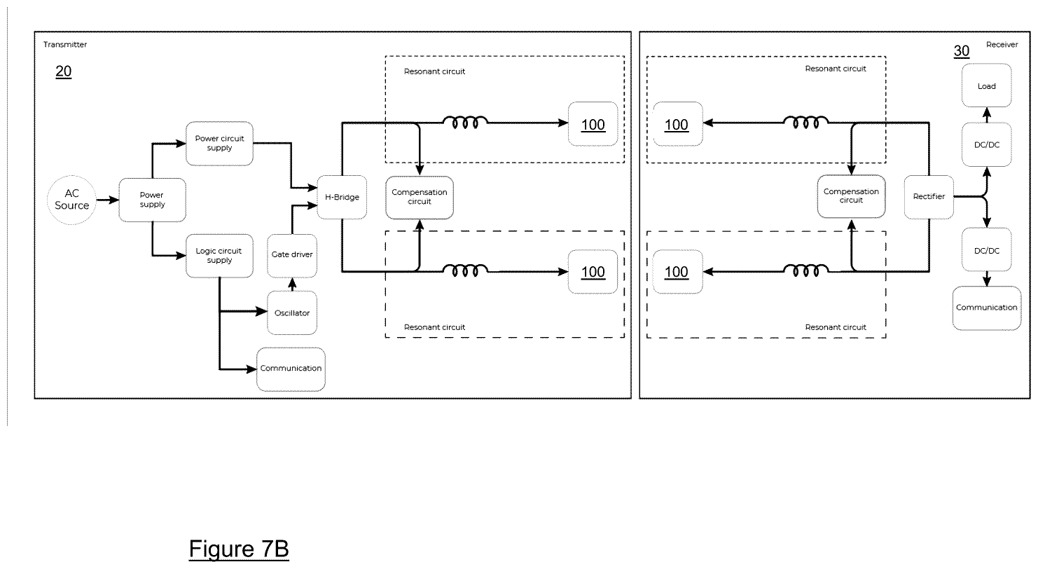

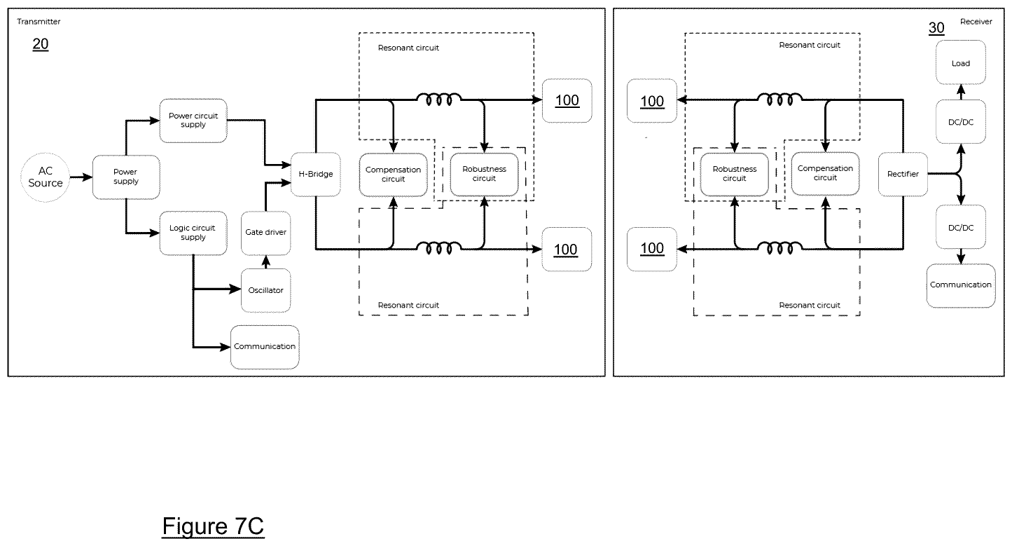

FIGS. 6A-6C provide exemplary functional configurations for the wireless power transfer system of FIG. 1 with one electrode assembly 100 at the transmitter 20 and one electrode assembly 100 at the receiver 30. FIGS. 7A-7C provide exemplary functional configurations for the wireless power transfer system of FIG. 1 with two electrode assemblies 100 at the transmitter 20 and two electrode assemblies at the receiver 30. A person skilled in the art would readily understand that the implementations illustrated in FIGS. 6A-6C and FIGS. 7A-7C are for illustration purposes only, and that other implementations could alternately be used.

Referring now concurrently to FIGS. 1, 2A-2D, 3, 4A-4D, 5A-5C, 6A-6C and 7A-7C, the electrical components 130 between the conductive plates 110 of each electrode assembly interact with the parasitic capacitive properties of the conductive plates 110 to: induce and/or assist resonance of the electrode assembly 100, and/or increase gain of the transmitter 20 or receiver 30 circuits associated therewith. The electrical components 130 between the conductive plates 110 of each electrode assembly thus: assist in making a resonant frequency of the electrode assembly 100 uniform thereby rendering a frequency of the electric field generated by the electrode assembly 100 more stable, in making an amplitude of the electric field generated by the electrode assembly 100 more uniform, and/or by making the shape of the electric field generated by the electrode assembly 100 more even in the surrounding the electrode assembly 100.

Although the present disclosure has been described hereinabove by way of non-restrictive, illustrative embodiments thereof, these embodiments may be modified at will within the scope of the appended claims without departing from the spirit and nature of the present disclosure.

1. An electrode assembly comprising:
a plurality of adjacent electrically conductive plates separated by a spacing therebetween; and
at least one electrical component interconnecting the adjacent electrically conductive plates;
wherein the plurality of conductive plates is connected to a resonant circuit.

2. The electrode assembly of claim 1, wherein a plurality of electrical components interconnects some of the adjacent electrically conductive plates.

3. The electrode assembly of claim 1, wherein the plurality of electrical components comprises at least one of the following: one or more component with inductive properties, one or more component with capacitive properties, or one or more component with inductive and capacitive properties.

4. The electrode assembly of claim 1, wherein the conductive plates have a circular shape.

5. The electrode assembly of claim 4, wherein the conductive plates consist of concentric rings or concentric hollow cylinders.

6. The electrode assembly of claim 1, further comprising an electrical connector electrically connecting each conductive plate to the resonant circuit.

7. An electrode assembly comprising:
a plurality of conductive plates separated by a spacing there between;
at least one electrical component interconnecting two spaced conductive plates; and
a supporting frame adapted for maintaining the plurality of conductive plates;
wherein the plurality of conductive plates is connected to a resonant circuit.

8. The electrode assembly of claim 7, wherein the supporting frame stacks the plurality of conductive plates.

9. The electrode assembly of claim 7, wherein consecutive conductive plates are interconnected by two or more electrical components.

10. The electrode assembly of claim 9, wherein the plurality of electrical components comprises at least one of the following: a component with inductive properties, a component with capacitive properties, or a component with inductive and capacitive properties.

11. The electrode assembly of claim 7, wherein the conductive plates are arranged as concentric rings.

12. The electrode assembly of claim 11, further comprising an electrical connector electrically connecting each conductive plate to the resonant circuit.

13. A wireless power transfer system comprising:
a transmitter including at least one electrode assembly; and
a receiver including at least one electrode assembly;
wherein each electrode assembly comprises:
a plurality of adjacent electrically conductive plates separated by a spacing therebetween, the plurality of conductive plates being connected to a resonant circuit adapted to generate a resonant electric field between the transmitter and the receiver to wirelessly transmit power from the transmitter to the receiver via resonant capacitive coupling; and
at least one electrical component interconnecting the adjacent electrically conductive plates.

14. The wireless power transfer system of claim 13, wherein the conductive plates are interconnected by two or more of the plurality of electrical components.

15. The wireless power transfer system of claim 13, wherein the electrical component comprises one of the following: a component with inductive properties, a component with capacitive properties, or a component with inductive and capacitive properties.

16. The wireless power transfer system of claim 13, wherein the conductive plates of each electrode assembly have a circular shape.

17. The wireless power transfer system of claim 16, wherein the conductive plates of each electrode assembly consist of concentric rings or concentric hollow cylinders.
